(19) United States
(12) Patent Application Publication
(10) Pub. No.: US 2011/0242110 A1
(43) Pub. Date: Oct. 6, 2011

(54) DEPICTION OF DIGITAL DATA FOR FORENSIC PURPOSES

(76) Inventor: Frederick B. Cohen, Livermore, CA (US)

(21) Appl. No.: 12/753,857

(22) Filed: Apr. 2, 2010

(51) Int. Cl. G06T 11/20

(52) U.S. Cl. 345/467

(57) ABSTRACT

A method and/or system that can be implemented on a computing device or tables or board game or otherwise uses a rule set to evaluate data about a situation and actors in order to provide advice regarding strategies for influencing actors and/or other outputs.

### COPYRIGHT NOTICE

Illustrative embodiments of the present invention are described below. In various embodiments, the present invention may be implemented in part using program source code, using graphical interfaces, using font tables, or using written tables, manuals, or other instructions. Thus, portions of material included in this submission is copyrightable and copyright is claimed by the inventor. Permission is granted to make copies of the figures, appendix, and any other copyrightable work solely in connection with the making of facsimile copies of this patent document in accordance with applicable law; all other rights are reserved, and all other reproduction, distribution, creation of derivative works based on the contents, public display, and public performance of the application or any part thereof are prohibited by the copyright laws.

### Precautionary Request to File an International Application, Designation of All States, and Statement that at Least One Applicant is a United States Resident or Entity

Should this document be filed electronically or in paper according to any procedure indicating an international application, applicant hereby requests the filing of an international application and designation of all states. For purposes of this international filing, all inventors listed on a cover page or any other document filed herewith are applicants for purposes of United States National Stage filing. For purposes of this international filing, any assignees listed on a cover page or any other document filed herewith are applicants for purposes of non-United States national stage filing, or, if no assignee is listed, all inventors listed are applicants for purposes of non-United States national stage filing. For purposes of any international filing, applicants state that at least one applicant is a United States resident or United States institution. Should this application be filed in as a national application in the United States, this paragraph shall be disregarded.

### APPENDIX

This application is being filed with a source code appendix comprising example computer program source code listings according to specific embodiments of the present invention. The entire contents of this appendix is incorporated herein by reference.

### FIELD OF THE INVENTION

The present invention relates to electronic digital devices and methods. In particular, the present invention relates to methods and/or systems involving display of digitally encoded characters or symbols generally using either a printed output or an electronic display output.

### BACKGROUND

Precise analysis, representation, and presentation of digital data has become increasingly important in recent decades. Legal disputes, including criminal proceedings, not un-commonly involve examination of one or more portions of digital data, such as email or text messages, digital trace data indicating a number of different digital actions, digital data representations of telephone or cellular phone locations or messages, etc.

In order to perform an examination of digital data, it is often necessary to represent or depict such data in a visual form, such as in a printed document or on a display screen. Explaining or documenting the results of examination also require depiction of the digital data. However, limitations in existing methods for representing digital data in printed or visual forms for many years have frustrated those attempting to perform or document forensic analysis of digital data. Despite the increasing importance of such digital forensic analysis, no method or system has yet become available to allow precise yet easy to read and understand representations of digital data.

Character encoding is commonly used to present digital data that represents text or other visual symbols. Character encoding is a term used in computer science to generally indicate a mapping between digital values and visual symbols (such as numerical digits, letters, punctuation marks, other visual symbols). A character encoding system consists of a code that pairs each character from a given repertoire with something else, such as a sequence of natural numbers, octets or electrical pulses. The terms character encoding, character set, and sometimes character map or code page can generally be considered synonymous. A character set generally pairs symbols with code units or bit sequences. At present, a very common code unit is an 8-bit byte, but other code units are known. Character encoding schemes are known that use 6-bit, 7-bit, 4-bit, variable-bit, and two-byte code units. In the discussion below the term bit sequence is to be understood to encompass any length of bits whose values (1's and 0's) are used to determine an assignment to a visual depiction of the bit sequence. A bit sequence according to specific embodiments of the invention can be either statically or dynamically determined to be either a fix-width number of bits, or a variable width number of bits. In some of the examples below a bit sequence of the invention is set to be closely analogous to an underlying “code unit” of fixed or variable size that is used in a character set or character mapping as described herein.

It is a characteristic of many character sets, including those most commonly used today, that some of the possible values of the bit sequences are either undefined or represent something other than a printable or visual symbol, such as a line-break, space, bell, back-space, page-break, etc.

### Fallback Fonts in the Prior Art

Some techniques have been used for making visible invisible characters in a character set. As one example, a fallback font is a typeface containing symbols for many Unicode characters, such that when a system encounters a character not part of available fonts, a symbol from a fallback font is used instead. For Unicode, a fallback font generally contains symbols representative of the various types of Unicode characters. Symbols in a fallback font can contain annotations such as the relevant Unicode block and the script system used. LastResort, for example, is a Macintosh® font used by the system to display glyphs that are not available in any other font. LastResort places glyphs into categories based on their location in the Unicode system and may provide indications regarding which font or script is required to view the characters. Example symbols of LastResort are square with rounded corners with a bold outline. In the left and right sides of the outline, the Unicode range that the character belongs to is given using hexadecimal digits. Top and bottom are used for one or two descriptions of the Unicode block. A symbol representative of the block is centered inside the square. In an example embodiment, one prototypic glyph per Unicode block is used because the total number of Unicode characters greatly exceeds the address space of a typical font structure, that may have a 16-bit glyph index that can store up to 65,536 glyphs. Unicode has now over 100,000 defined characters, with an address space of over one million characters. Using this one-glyph-per-block generalization, the Last Resort font is still capable of showing a glyph for every character in Unicode, though the symbols are not unique.

As an additional example, the Unicode BMP Fallback font contains a glyph for every character in the basic multilingual plane. Each glyph consists of a box containing the four hex digits corresponding to the Unicode value. The font is generally used for debugging purposes and does not depict readable text other than the hexadecimal value.

Generally, however, fonts such as those described above do not have symbols for non-printing characters, such as end-of-line, backspace, etc.

### SUMMARY OF THE INVENTION

The invention in its various specific aspects and embodiments involves methods and/or systems and/or modules that provide a variety of different functions relating to depictions (e.g., via a display, projector, or print-out) of digital data.

One example implementation of the invention is provided in the Source Code Appendix submitted with this specification. This example provides logic instructions executable in a logic processing system that causes the system to receive as inputs digital information and provide as an output a printed or visual display of the digital information that allows each bit sequence to be uniquely depicted and/or identified. A typical digital input file may include a mixture of bit-sequences, some of which encode normally displayed symbols, and others of which encode other data. A typical digital input file may include bit-sequences that are primarily fixed-width (such as 6-bit or 8-bit bytes, or 32-bit Unicode codes) or may include variable-width bit-sequences, such as are common in various compression schemes and also may be used in various character encoding systems.

A further understanding of the invention can be had from the detailed discussion of specific embodiments below. For purposes of clarity, this discussion may refer to devices, methods, and concepts in terms of specific examples. However, the method of the present invention may operate with a wide variety of types of devices. It is therefore intended that the invention not be limited except as provided in the attached claims.

Furthermore, it is well known in the art that logic or software systems or systematized methods can include a wide variety of different components and different functions in a modular fashion. Different embodiments of a system can include different mixtures of elements and functions and may group various functions as parts of various elements. For purposes of clarity, the invention is described in terms of systems that include many different innovative components and innovative combinations of components. No inference should be taken to limit the invention to combinations containing all of the innovative components listed in any illustrative embodiment in the specification, and the invention should not be limited except as provided in the embodiments described in the attached claims.

Various aspects of the present invention are described and illustrated in terms of graphical interfaces and/or displays that user will use in working with the systems and methods according to the invention. The invention encompasses the general software steps that will be understood to those of skill in the art as underlying and supporting the functional prompts and results illustrated.

All publications cited herein are hereby incorporated by reference in their entirety for all purposes. The invention will be better understood with reference to the following drawings and detailed description.

The discussion of any work, publications, sales, or activity anywhere in this submission, including any documents submitted with this application, shall not be taken as an admission that any such work constitutes prior art. The discussion of any activity, work, or publication herein is not an admission that such activity, work, or publication existed or was known in any prior jurisdiction.

### BRIEF DESCRIPTION OF THE DRAWINGS

FIG. 1A-E are tables illustrating example sets of bit sequence depictions according to specific embodiments of the present invention.

FIG. 2A-B illustrate output of a test phrase using an example depiction set according to specific embodiments of the present invention.

FIG. 3 illustrates an example standard printout of two ASCII files (named test1 and test2) used to illustrate aspects of the invention.

FIG. 4A-B illustrate example forensic outputs of the test1 and test2 files of FIG. 3 using example forensic depictions with non-coded spacing used for printout according to specific embodiments of the invention, using a “small” depictions set.

FIG. 5A-B illustrate example forensic outputs of the test1 and test2 files using example forensic depictions with added formatting (or spacing) according to specific embodiments of the invention, using a “full” depictions set.

FIG. 6A-B illustrate example forensic outputs of the test1 and test2 files using example forensic depictions with added formatting placed in a gridded output according to specific embodiments of the invention, using a “full” depictions set.

FIG. 7A-B illustrate example forensic outputs of the test1 file using example forensic depictions with no added formatting or spacing according to specific embodiments of the invention, using full and small depictions set.

FIG. 8A-C illustrates output of a diff test using an example depiction set according to specific embodiments of the present invention.

FIG. 9A-C illustrate examples of depictions of database-type data or other data with regular delimiters according to specific embodiments of the present invention. FIG. 9A illustrates an example where every bit sequence is mapped to a unique forensic depiction. FIG. 9B illustrates an example where some delimiting values are mapped to the same forensic font.

FIG. 10A-E illustrate a display of an email message with header information according to the prior art.

FIG. 11A-C illustrate display of an email message with header information using an example depictions and applying some formatting according to specific embodiments of the invention.

FIG. 12 illustrates a representative example logic device in which various aspects of the present invention may be embodied or that can be used to provide interface to a system according to the invention.

### DESCRIPTION OF SPECIFIC EMBODIMENTS

Before describing the present invention in detail, it is to be understood that this invention is not limited to particular compositions or systems, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content and context clearly dictates otherwise. Thus, for example, reference to “a device” includes a combination of two or more such devices, and the like. Unless defined otherwise, technical and scientific terms used herein have meanings as commonly understood by one of ordinary skill in the art to which the invention pertains. Although any methods and materials similar or equivalent to those described herein can be used in practice or for testing of the present invention, the preferred materials and methods are described herein. Unless the context requires otherwise, throughout the specification and claims which follow, the word “comprise” and variations thereof, such as, “comprises” and “comprising” are to be construed in an open, inclusive sense, that is as “including, but not limited to.” The headings provided herein are for convenience only and do not interpret the scope or meaning of the claimed invention.

### Overview

In the early days of computing, there were two main technologies for presentation of digital data in readable form: dots and lines. The line technology used continuous media, such as deflections of a cathode ray in a cathode ray tube (CRT) or movement and up/down motion of a mechanical pen in two dimensions (the pen plotter). The dot technology consisted largely of light emitting diodes, lamps of various sorts, displays with fixed shape elements that were on or off at any given moment, and eventually the cathode ray tube with fixed scan patterns. Fonts for plotters and line drawing CRTs originally consisted of sequences of line segments drawn one after another with pen up and down movements to break line continuity. Font designers created an array of different fonts and used coding schemes for representation, such as the American Standard Code for Information Interchange (ASCII), and Extended Binary Coded Decimal Interchange Code (EBCDIC). Each ASCII, EBCDIC, or other coded symbol was assigned a font element for display purposes, with the exception of some special characters, such as <backspace>, <space>, <tab>, and <carriage-return> used for location control within a line, and characters such as <line-feed> and <form-feed> for movement within the page and movement from page to page.

As display and printer technology improved, character sets (also referred to as fonts) became far more complex. In many fonts, variable height and width, and a wide array of different symbol sets are placed within font families. Boldface, underlines, and similar things were added to reflect the printer methods of using carriage return or backspace and printing over the same location again and again to produce similar effects, fonts were developed for multiple languages, and ultimately Unicode, a 2-byte coding scheme came about to help handle the explosion in the number of symbols desired within a font. While there are many other codings for bits in widespread use, the present discussion repeatedly uses 8-bit fonts representing the ASCII character set as an example for illustrating various embodiments of the invention. This is for convenience of space and understanding, but the inventions in major aspects applies equally to other coding schemes and can be extended to larger and smaller symbol sets and other similar schema.

Much of the development in font or character-set technology of the past several decades has involved increasing the flexibility of character sets and allowing for encoding characters in different languages, styles, etc. However, according to specific embodiments of the invention, the invention recognizes that presentation of digital data (referred to at times as digital trace evidence) for legal purposes has substantially different requirements than for other purposes, for a number of reasons. These reasons include, without limit: (1) legal mandates that restrict page formats (e.g., require the use of pleading paper for certain submissions); (2) subtle differences in presentation that may be important for bringing clarity to the information presented (e.g., the difference between several spaces and a tab character may be vital to the issues at hand); (3) challenges may be brought based on what is unclear (e.g., how can an observer tell from what is on this page that what an asserter is claiming about this text is in fact true?); and (4) what is visible in many fonts may not properly reveal what is in fact present in the underlying digital forensic data, leading to errors and omissions.

Specific embodiments of the present invention address one or more of these requirements by printing or otherwise presenting digital data using the novel concept of a depiction set specifically designed for precise and unambiguous presentation of digital data. At times such a depiction set may also be referred to using the trademark name Forensic Font™, Forensics Font™, Forensics Fonts™, or Forensic Fonts™. A depiction as used herein generally can be understood as a single graphical representation that is output to indicate a bit sequence. Depictions according to the invention will generally include a glyph or symbol (e.g., “a” “2” “!” “a”) and may optionally also include an indication of a numerical value of a bit sequence, which will generally be digits optionally also expressed with an indication of the modulus or base used in the representation (e.g., “7”, “07”, “0x07”, “07_{g}”, “07₁₀”, “07_{d}”, “07ₕ”, etc.). In some embodiments, the numerical value may be represented graphically, such as using dots or dashes. At times herein, depictions that only include a glyph are referred to as “small depictions” and those that use a glyph plus a numerical value indicator are referred to as “full depictions.”

A depiction set according to specific embodiments of the invention provides a defined set of depictions that is precise, accurate, and preferably is unique in its mapping of bit sequences to symbols. (Though, with some possible exceptions in specific embodiments, as described below). The uniqueness property is highly desirable to avoid confusion and allow definitive answers to be given to specific questions. In the context of the invention, one-way uniqueness indicates that for every depiction, the viewer knows unambiguously what is the bit sequence in the original digital data. Some embodiments of uses of the invention may also provide two-way uniqueness, in that a particular bit sequence is always output as a particular symbol. In other embodiments, bit sequences may output different depictions based on context, such that the sequence “00000001” might output as the symbol ̂a in a portion of digital data that represents text and might output as a field delimiter (e.g., the symbol ̂^{[}) in a portion of digital data that represents database entries.

A depiction set according to the invention is not one particular set of depictions, but is a set of depictions that meets the characteristics described herein. Thus, the invention encompasses many different depiction sets, such as different sets for different languages, different sets to correspond to differently encoded data (ASCII, EBCDIC, etc.), or for different purposes, such as depiction sets wherein each depiction includes a symbol and a further visual indication of the bit sequence, such as dots, dashes, or numeric digits.

### Characteristic of Depiction Sets of the Invention

In specific embodiments, the invention involves one or more depiction sets (or symbol sets) that generally encompass one or more desirable characteristics for digital forensics. These characteristics have been developed and determined in association with the invention in order to meet the long felt need for a way to precisely represent digital data. Characteristics of depiction sets according to specific embodiments of the invention are listed and discussed below. While a depiction set according to specific embodiments of the invention may not embody all the characteristics discussed below, presently preferred embodiments of the invention conform to a substantial majority or all of these characteristics.

Each Depiction should Visually be Clearly Different from all Other Depictions

According to specific embodiments of the invention, this characteristic provides clarity regarding which bit sequence (or byte or value) has been identified as present in the underlying data. If this is not true, then there will be confusion both for the person performing forensic examination and for those who review the results, including the lawyers, judges, juries, clerks, and public. Legal documents are often printed, scanned, reprinted, and go through other similar machinations. While it is impossible to always preserve all of the characteristics of what was originally present, it is important to provide enough of a difference between depictions so that these differences are likely to survive multi-generation copying, scanning, and a wide range of different displays or printers.

According to specific embodiments of the invention, each depiction is generally of the same width and height, with the possible exception of depictions for spacing purposes, such as for tab characters. While this characteristic may be modified in some embodiments, depiction sets with this characteristic allow depictions to be compared to other depictions around them for location. While this may destroy the appearance of tab characters and other similar presentation values, it provides clarity around issues like spaces, columns, helps with fixed width fields, such as databases, and allows the column and row to be clearly seen and specified verbally, which is vital for providing accurate testimony in legal matters. In some situations, such as presenting formatted text to a reviewer, fixed-width depictions may be placed or formatted generally according to the spacing indicated by the depictions (such as tabs or line or page breaks). In such an instance, the invention will preserve to the observer that each bit sequence is represented by a visual depiction, and that any spacing is not part of the underlying forensic data, but is provided only to make the data easier to read.

Each Depiction should be Familiar

According to specific embodiments of the invention, each depiction of a set is understandable to the viewer with minimal added interpretation, so that it looks similar to what might appear on a display of the same depiction on a screen or printer. As an example, the phrase “Help me, please!” should still be readable as such by someone who could read it in the normal display mode, or the depiction set will create more confusion than it removes. Thus the character set for EBCDIC will have to reflect EBCDIC coding, the one for ASCII will have to reflect ASCII coding, etc.

In some embodiments, output for forensic purposes according to specific embodiments of the invention may be a mixture of native normally printed symbols and assigned forensic depictions. Thus, when forensically analyzing a formatted web-page, for example, a method according to specific embodiments of the invention may use the symbols defined by the normal font or depiction set of the web page for normally printable symbols, and use assigned forensic depictions for non-printing bit sequences and for any normally printable symbols that are not distinct from other normally printable symbols.

Each Depiction should be Printable or Displayable

Each depiction must be printable so that a <space>, <tab>, <carriage-return>, <backspace>, <escape>, and other “non-printable” characters can be clearly seen and distinguished from each other on the printed page or on a display screen. This is desirable because, in many cases the issue in dispute is the non-printable characters, and even when they are not in dispute, it makes interpretation far easier when the non-printing characters are clearly revealed rather than being hidden. As discussed above, while many character sets provide printable symbols for most of the first 128 bit sequences within the depiction set, many have a large portion of the codes from 128-255 as non-printing codes or unassigned codes.

According to further specific embodiments, each depiction self-indicates the underlying bit sequence that produced it. This makes it easier to determine the origin of the data that produced the depiction, and allows the individual examining it to definitively know the basis for the display provided. For example, the bit sequence ‘00000011’ (byte code ‘03’) may mean different things in different contexts.

In general, a side effect of these criteria is that the depictions will take up more space on a page than the normal font would take up for the same level of readability, and it will have some differences from the fonts commonly used for other purposes, such as a more distinct difference between the number zero “0” and the capital letter “O”, the number one “1” and the lower case letter “l”, the upper case letter “I” and a vertical slash “|”, and so forth.

### Other Characteristics

From the description herein, it will be understood that the invention in specific embodiments involves a method for presenting digital data in a digital system or environment of a type that generally assigns visual symbols to bit sequences (such as the printing symbols of the ASCII or EBSIDIC character set) where some bit sequences of the system are not assigned to visual symbols (such as the non-printing characters of the ASCII or EBSIDIC character set). While in some embodiments, the invention will assign a new forensic depiction to each bit sequence, in general, at a minimum, the invention assign a forensic depiction to every bit sequence that is not assigned to a visual symbol in the digital environment, with each forensic depiction visually distinct from every other forensic depiction and visually distinct from every visual symbol so that every bit sequence is associated with a depiction. This allows the invention to output to a visual media where every bit sequence is output as a visual depiction. In some embodiments, the invention ensures that each and every bit in the underlying digital data is reflected in an output depiction.

In further embodiments, the digital environment or data system might include some visual symbols that are not readily visually distinct from other visual symbols (such as the number “1” and the letter “l”). In such a case, the invention assigns a modified distinct normally printable symbol or a forensic symbol to at least one of any set of two or more bit sequences that are assigned to normally pintable symbols that are not visually distinct.

In further embodiments, the invention assigns forensic depictions for each bit sequence and does not use any the underlying visual symbols. These forensic symbols are preferably selected to be visually recognizable as the normally printable symbol.

Thus, in specific embodiments, the invention can be understood as in some implementations providing at least two types of forensic depictions: (A) forensic depictions for normally printable bit sequence; and (B) forensic depictions for normally non-printing bit sequence.

### Example Depiction Sets (Forensic Fonts™)

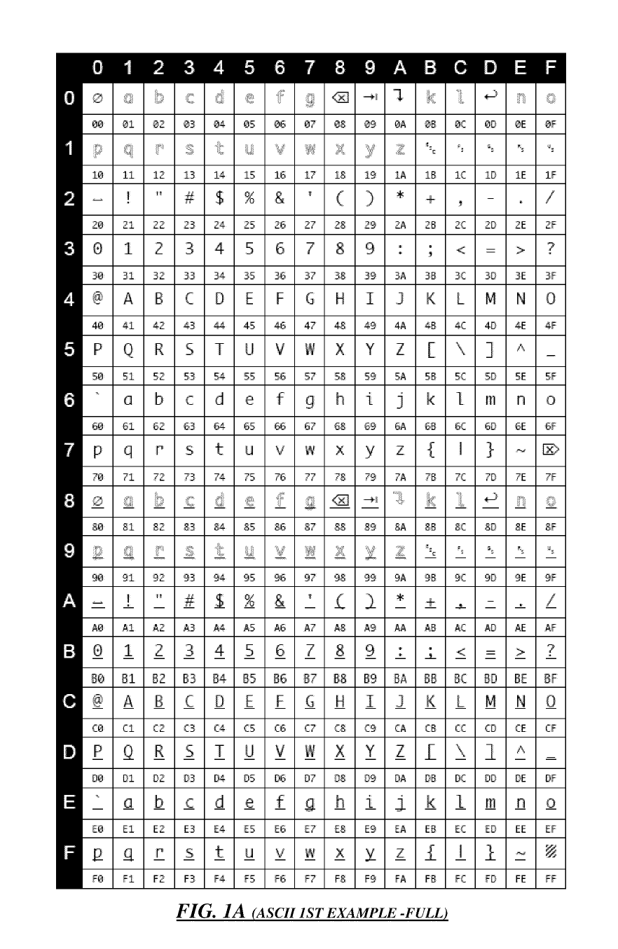

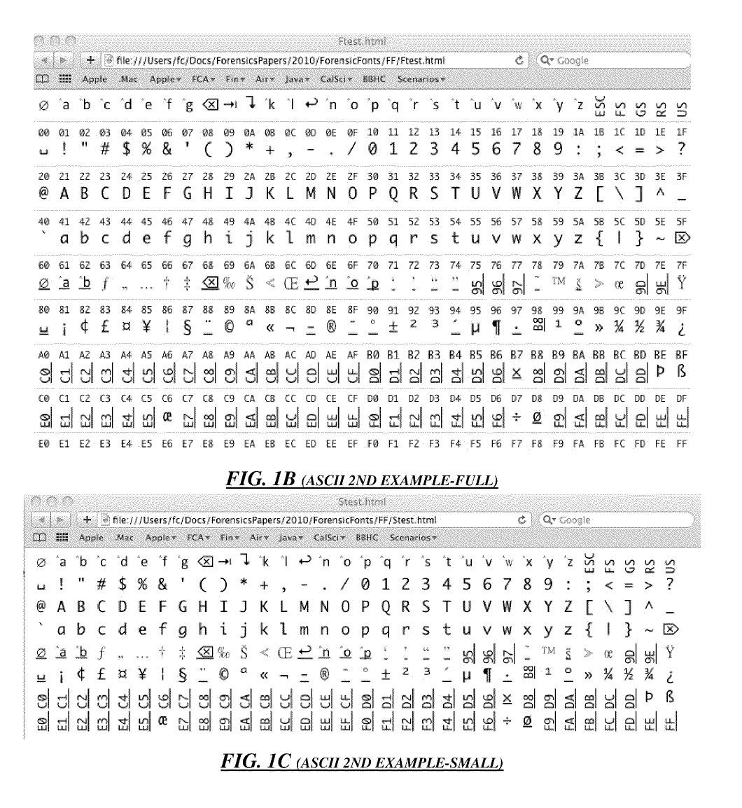

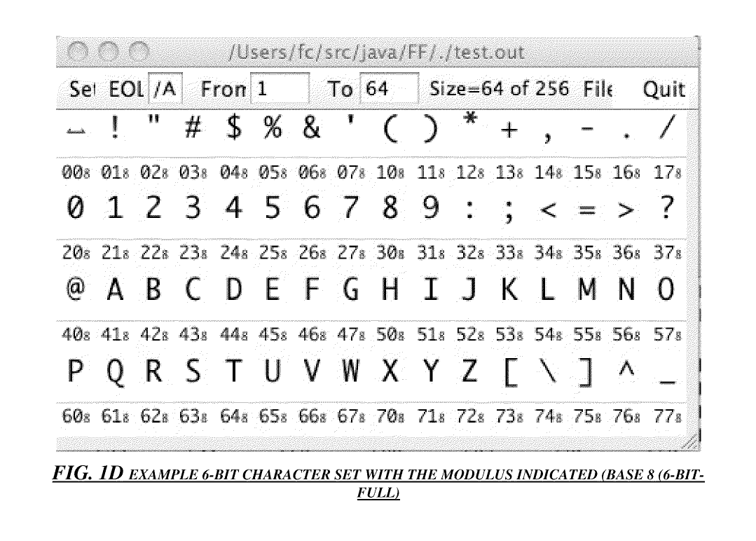

FIG. 1A-E are tables illustrating example sets of bit sequence depictions according to specific embodiments of the present invention. In one example specific embodiment, a depiction set for ASCII was developed along with an example software tool to convert any file into a display using this character set. (Example source code is provided in Appendix A.) FIG. 1A illustrates an example depiction set table that covers ASCII codes ranging from 0x00 through 0xFF, with each code corresponding to a printable fixed-width depiction as shown.

In a further embodiments of the invention, a depiction set or Forensic Font™ is provided that includes a glyph and a further representation of the bit sequence to which that glyph is assigned. Thus, in the example in FIG. 1A, each individual character is not be just the symbol (such as “a” for 0xE1), but also includes digits indicating the value, such that the depiction for 0xE1 in the example is

$$\frac{\underline{a}}{E 1} .$$

In such an embodiment, each depiction in a Forensic Font™ depiction set includes both a distinct unique readable symbol and a numerical value. In the example, the two hexadecimal digits “E1” represent a bit sequence as a hexadecimal value, but three digits could be used to indicate a one-byte value in octal or decimal, four to indicate a two-byte value in hex-code, etc. An arrangement of small symbols, such as dots or dashes, could also be used to indicate the underlying bit sequence.

FIG. 1B illustrates a second example of forensic depictions using “full” depictions having a upper glyph (e.g., “̂a”, “!”, “A”, “a”, “̂a” “i” and sideways C1, E1 in the second column of the figure), and a lower hexadecimal value (e.g., 01, 21, 41, 61, 81, A1, C1, E1). FIG. 1B also illustrates output of a forensic font set as an HTML file, as described herein.

FIG. 1C illustrates an example of forensic depictions as in FIG. 1B, but using “small” depictions having only a glyph for each bit sequence. FIG. 1C also illustrates output of a forensic font set as an HTML file, as described herein.

FIG. 1D illustrates an example of “full” forensic depictions for 6-bit bit sequences with the modulus or base indicated in the value portion of each depiction, in this example indicated by a subscript “8”, e.g., “01₈”. FIG. 1D also illustrates output of a forensic font set generated by a program written in the Java language.

FIG. 1E illustrates a third example of forensic depictions using “full” depictions having a upper glyph and a lower hexadecimal value for 8-bit sequences using ASCII encoding with the modulus or base indicated in the value portion of each depiction, in this example indicated by a subscript “g”, e.g., “01_{g}”. FIG. 1E also illustrates output of a forensic font set as an HTML file, as described herein.

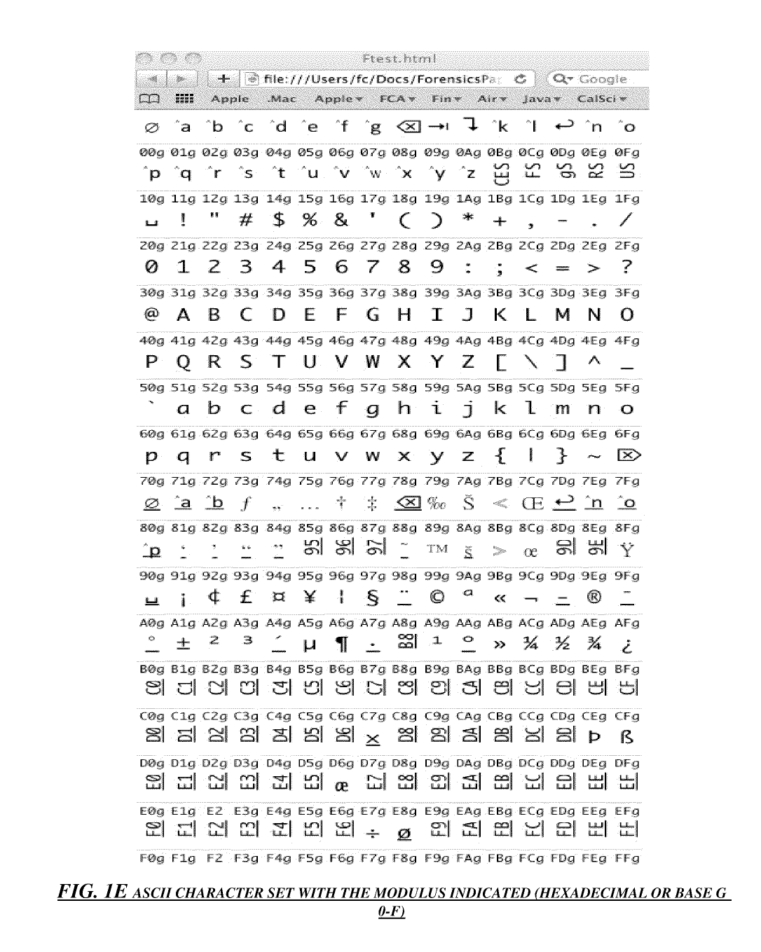

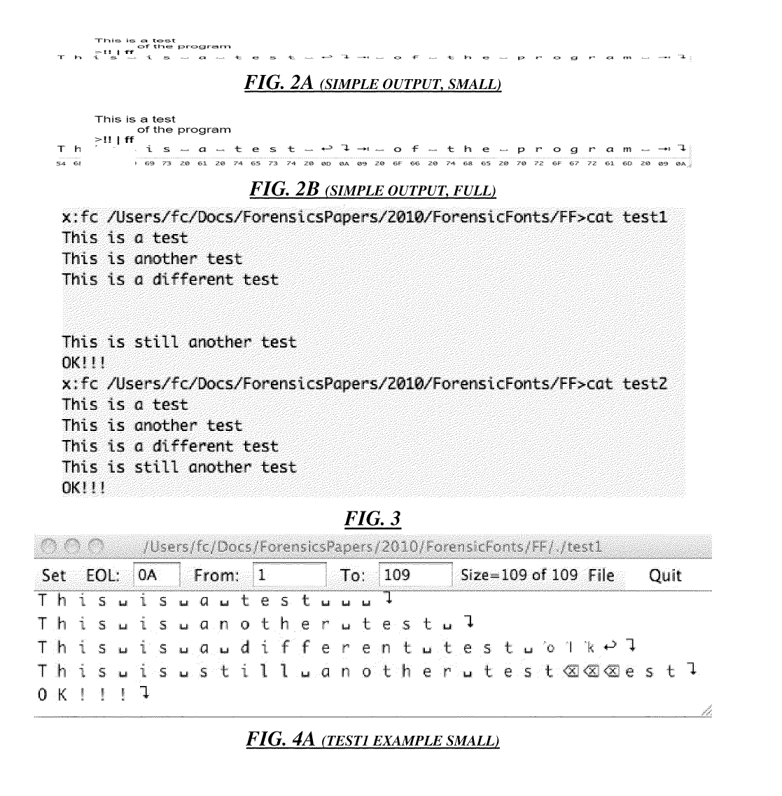

FIG. 2A-B illustrate examples showing the input (upper) and output (lower) of a simple phrase according to specific embodiments of the invention. In the lower output portion, each bit segment in the input has been output as a depiction from a set according to specific embodiments of the invention. In the example shown in FIG. 2B, the set used is one that includes a symbol and a numerical value as shown. The example indicates the presence of the space prior to the tab, and the presence of the carriage return prior to the newline. As discussed above, in this example, the full font includes both the printable depiction and the hexadecimal value of the symbol, separated by a line. This provides precise information about what bytes are present within the output. FIG. 2A illustrates the output using only the glyph for each bit sequence.

A “small” version of the font is also usable to depict all of the characters without including the hexadecimal digits, as shown in FIG. 1C. All of the printable characters, spaces, carriage return, newline, and tab characters are still displayed and clearly differentiable, while the content is relatively readable. In many instances, this presentation is more useful, particularly when readability is more of an issue than the particular byte values involved. A system according to the invention can provide a very quick way for a viewer to switch between full and small depictions when viewing output on a dynamic display.

Example Outputs and Example Output of “diff” Command

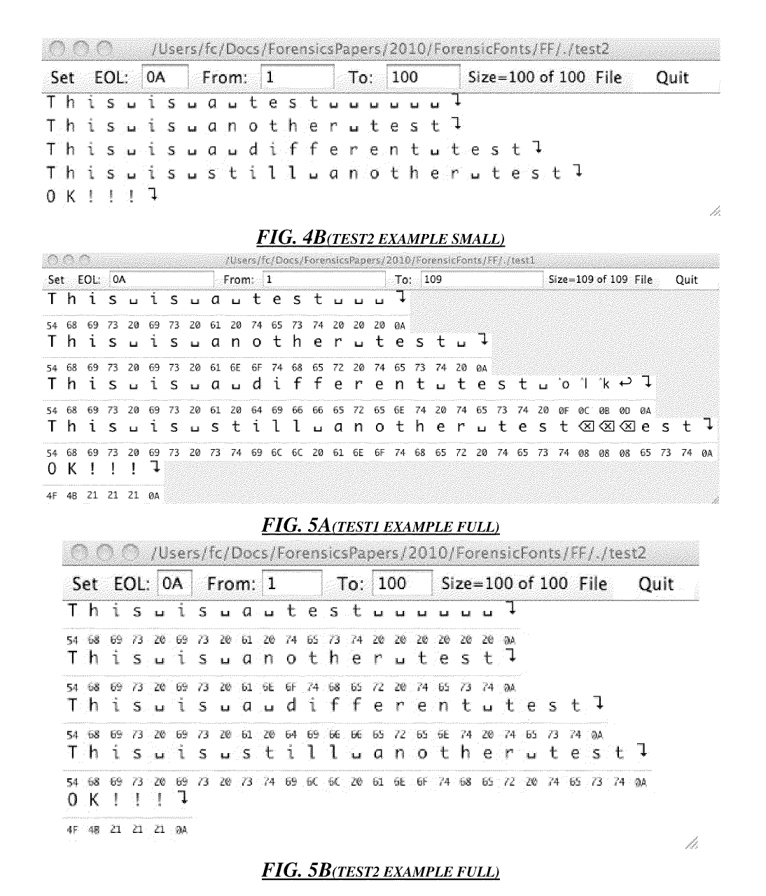

As a further example, consider a situation in which the printed output of two digital data files (or traces) appeared the same when printed by normal means, but where application of a diff command showed that many lines of the file contained differences. FIG. 3 illustrates an example standard printout of two ASCII files (named test1 and test2) used to illustrate aspects of the invention. In this example, the well-known UNIX cat command is used to illustrate display of the underlying digital files named test1 and test2. FIG. 4A-B illustrate example forensic outputs of the test1 and test2 files of FIG. 3 using example forensic depictions with non-coded spacing used for printout according to specific embodiments of the invention, using a “small” depictions set.

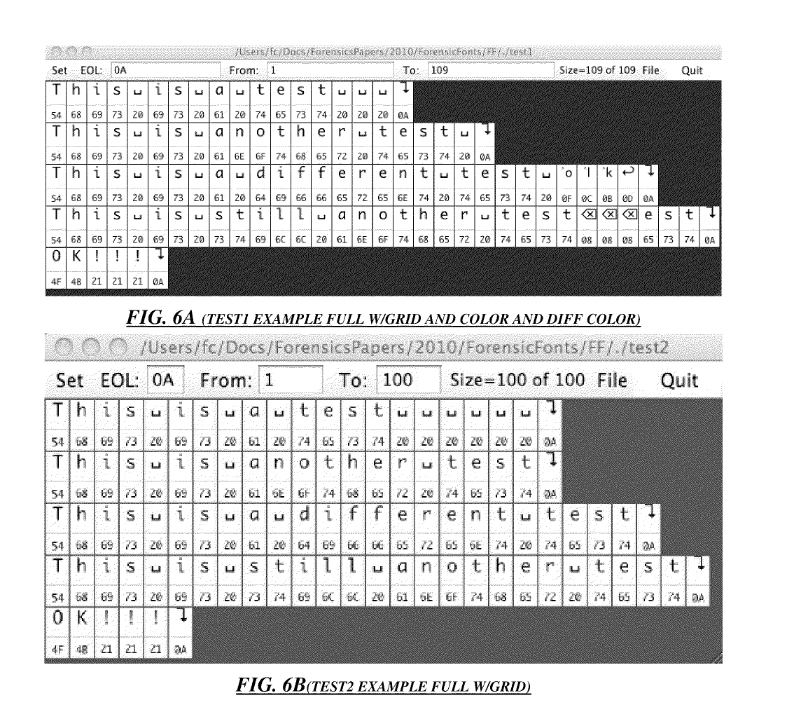

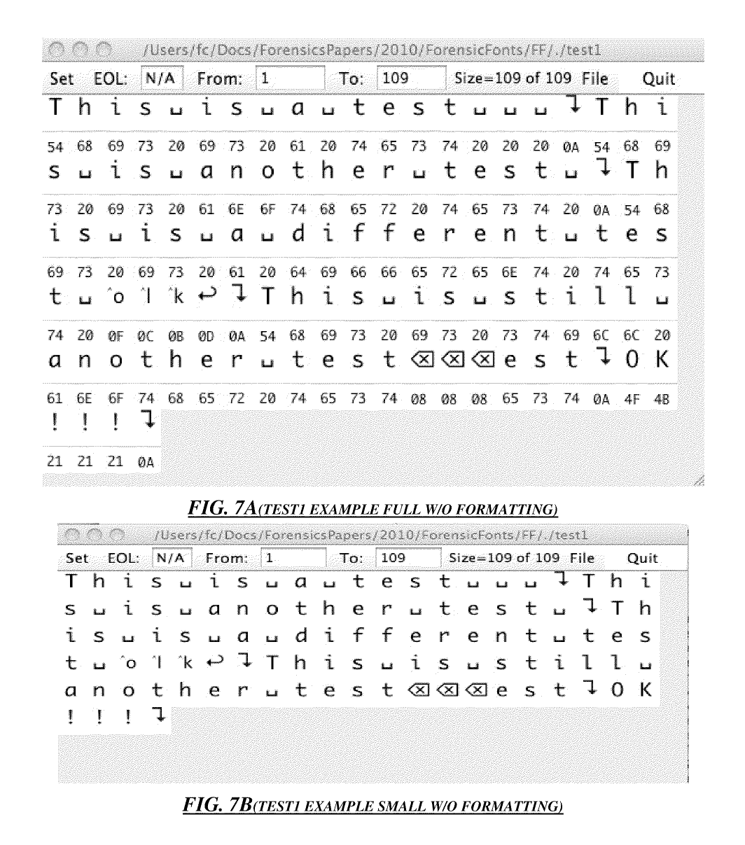

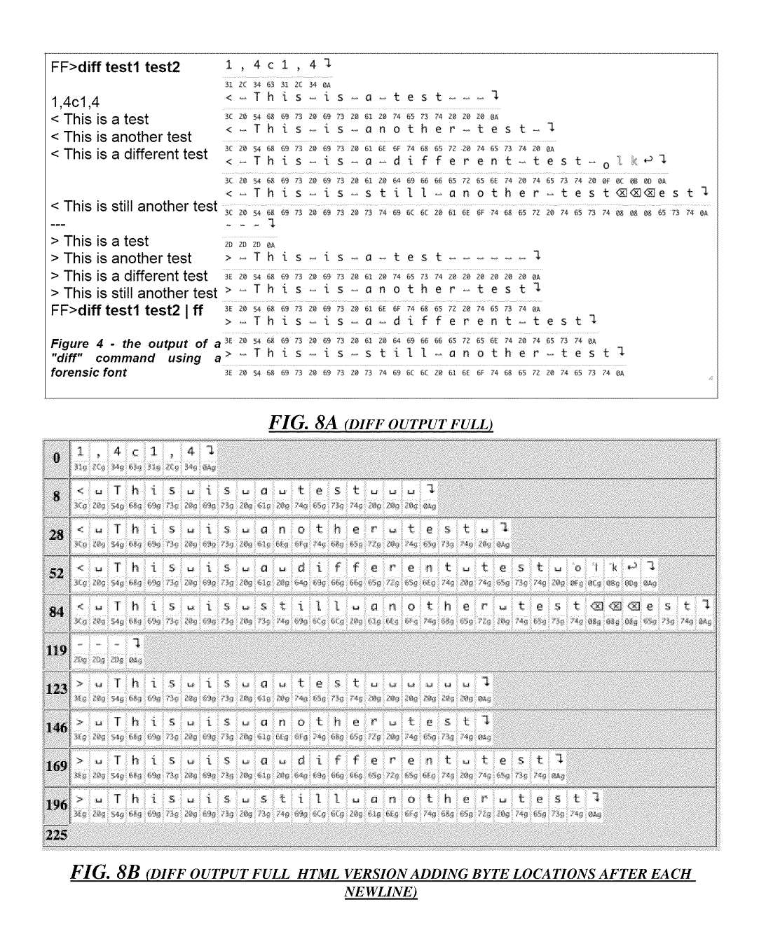

FIG. 5A-B illustrate example forensic outputs of the test1 and test2 files using example forensic depictions with added formatting (or spacing) according to specific embodiments of the invention, using a “full” depictions set. FIG. 6A-B illustrate example forensic outputs of the test1 and test2 files using example forensic depictions with added formatting placed in a gridded output according to specific embodiments of the invention, using a “full” depictions set. FIG. 7A-B illustrate example forensic outputs of the test1 file using example forensic depictions with no added formatting or spacing according to specific embodiments of the invention, using full and small depictions set.

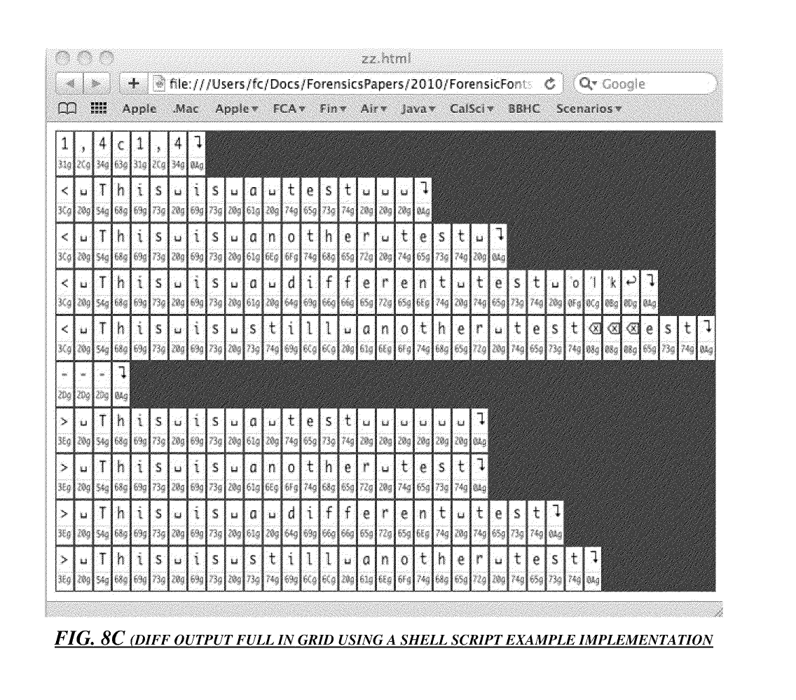

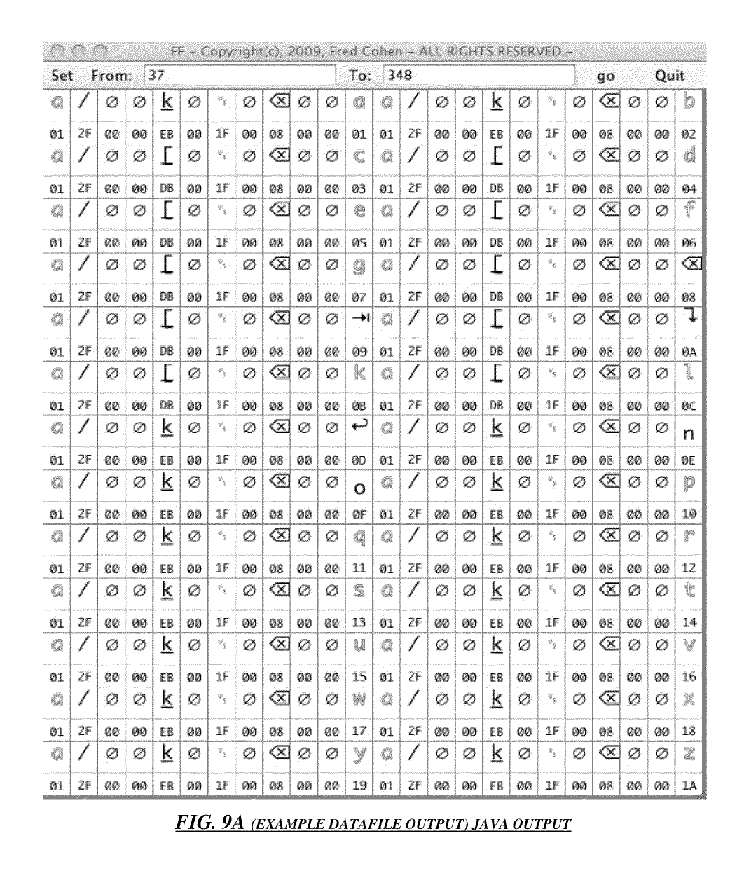

FIG. 8A-C illustrates output of a diff test using an example depiction set according to specific embodiments of the present invention. In this example, the well-known UNIX duff command is used to illustrate display of the differences in the underlying digital files named test1 and test2. In the illustrated example, the output of this command indicated that there was a difference in lines of the file that appeared to be identical on the output display. (In the actual case upon which this example is based, no forensic font was available, and it was not immediately obvious what the differences were. As a result, some time and effort were wasted, and in a less careful examination, portions of the results might have been missed.) By using a Forensic Font according to the invention, the difference becomes immediately obvious. The examples shown in FIG. 8A-C demonstrate output of a diff command using the invention. In this example, the displayed output is presented next to the input, and typically appears in a separate windows (since the display is not available in the command terminal window). In this example, using the invention, the differences are immediately obvious. The file test1 has three spaces before the end of line, while test2 has six; in the next line, test1 has an extra space before the end of line; in the 3rd line, there are control characters in test1; and the last line of test1 has three backspaces causing e, s, and t, to be overwritten with identical characters in test1. Only the presence of differences in the third line are demonstrated in the normal output of the diff command. FIG. 8B includes as a further guide to interpreting the underlying bit sequence data, position numbers at the each indicate the position of the bit sequence just preceding the displayed depiction. The placement and format of this number can vary in different examples, including placing the indicating at the end of lines, or encoding indications in hexadecimal or octal. In general terms, this output displays bit sequence count information in addition to the bit sequence depictions.

An Example from a Database File

Another example where the invention is useful, is in depicting and reviewing the contents of data with fixed width fields, such as database or possibly spreadsheet files. For example, in examining a binary file that is part of the storage of a file indexing system, the file format is not immediately apparent, and there are various binary characters present between strings. By presenting these results using a forensics font, the database structure can be seen with some additional clarity. Using a tool according to specific embodiments of the invention, a viewer can realign the bit sequences by, for example, simply resizing a browser window or using viewing features as further described herein.

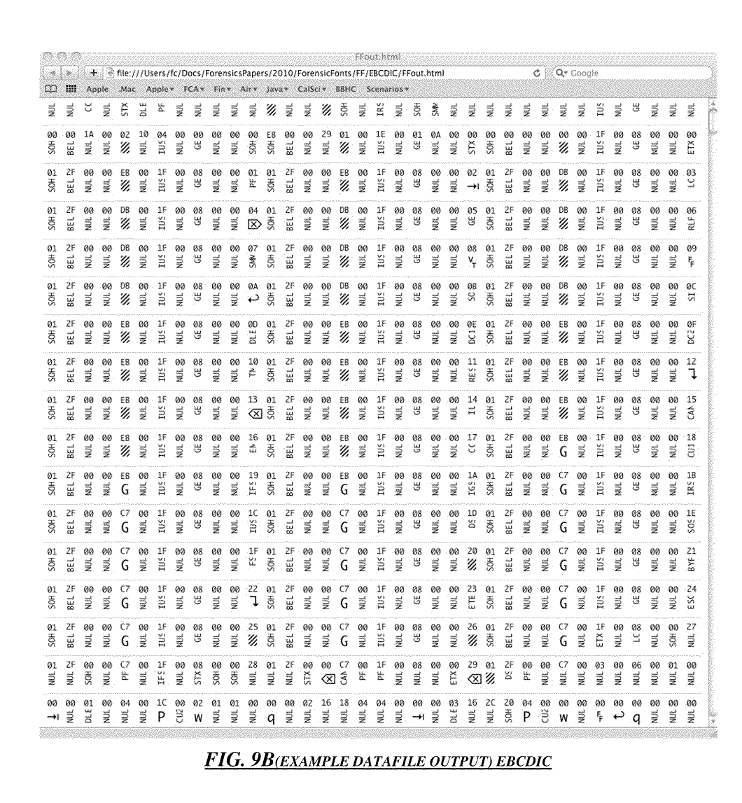

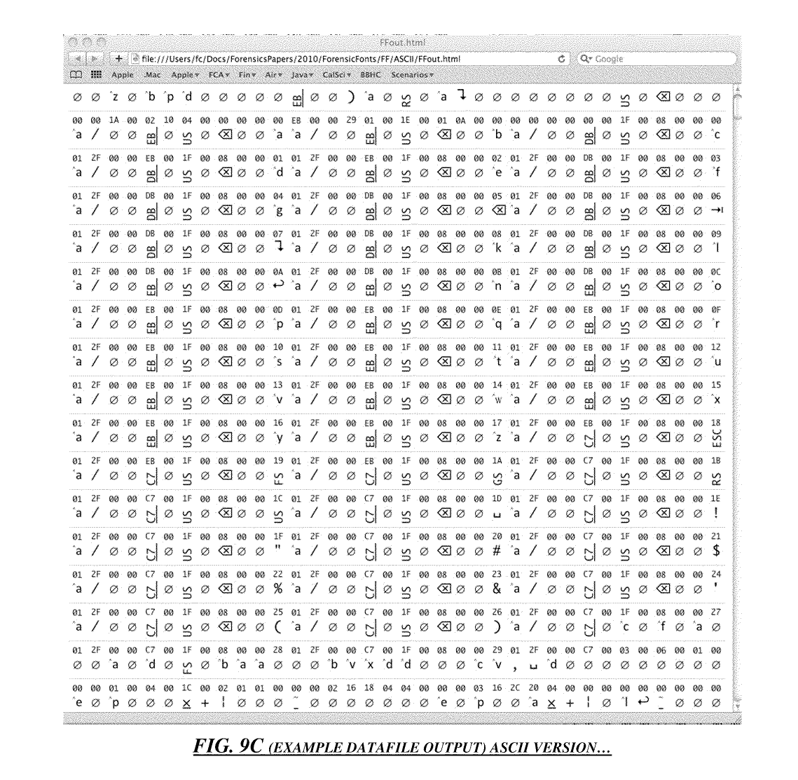

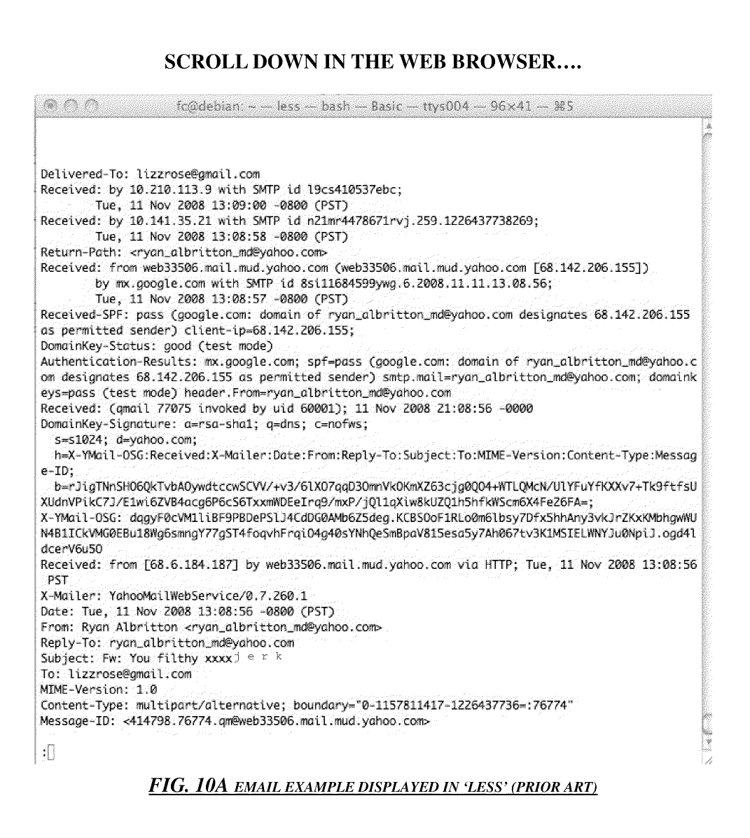

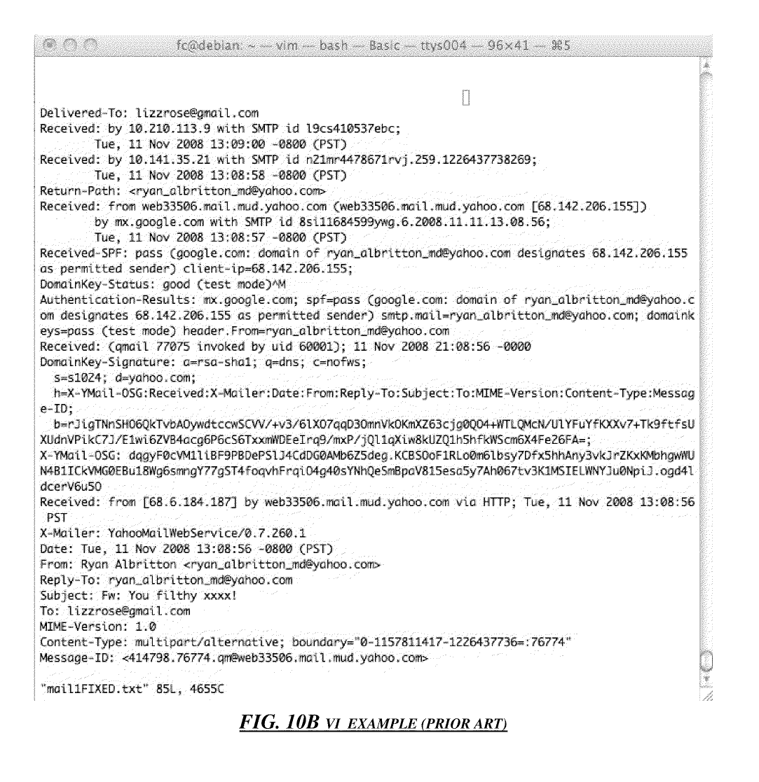

FIG. 9A-D illustrate examples of the depiction of an example “database” type digital file (in this example, a worksheet from a spreadsheet program in WK4). In this example, the width of the display can be adjusted by a viewer until the characters visually appeared to align. The result is that using the visual capacity of the human observer, an alignment of fields within this file can be readily ascertained, often in a matter of seconds. Different portions of the file might have different periodicity, and further adjustments can be made on a region-by-region basis to gain insight into the content, and to allow further examination to proceed. Using this tool, it's often easy to identify bit sequences that are used as delimiters in the underlying data (such as bit sequences indicating field breaks). With those delimiters, the tool can be used specifying a delimiter to be replaced by new lines. In this instance, a fixed width of the forensic font is particularly helpful in finding underlying data structure. However, when there is flexible data structure, additional tools may be helpful.

As an example, using a table depiction may allow table areas to be differentiated by the presence of characters within the input file, with table rows differentiated by different symbols. Again, using the ability to change widths dynamically, and the forensics fonts fixed width and display of all characters and character codes, the viewer can rapidly detect structure, to pick that structure, and undertake more detailed examination.

An Example from a Printout

Another quite common example occurs when attempting to print. Many printing mechanisms perform alterations on the original input in order to depict it within the output media, as well as for the purpose of pleasant appearance. While this is certainly useful for many purposes, in presenting content of forensic value, it is often more important for the output to precisely and accurately reflect the underlying digital input data, and far less important that the output look pleasing. Among the more common problems faced by the observer looking at a printout, are the misalignment of tab stops; the kerning of characters and spaces so as to make the actual number or presence of spaces unclear, and the alignment of characters from line to line uneven; the removal of individual or consolidation of multiple blank lines; the continuation of characters from one line into subsequent lines when the depiction is not wide enough to fully display the characters in a line within a single line (wrap around); and the removal, or different uses of nonprinting characters. Each of these issues produce difficulties for the examiner, particularly in court, where other tools are not available to bring clarity, both in understanding and explaining the printout, and difficulties for the trier of fact and legal counsel in understanding the testimony.

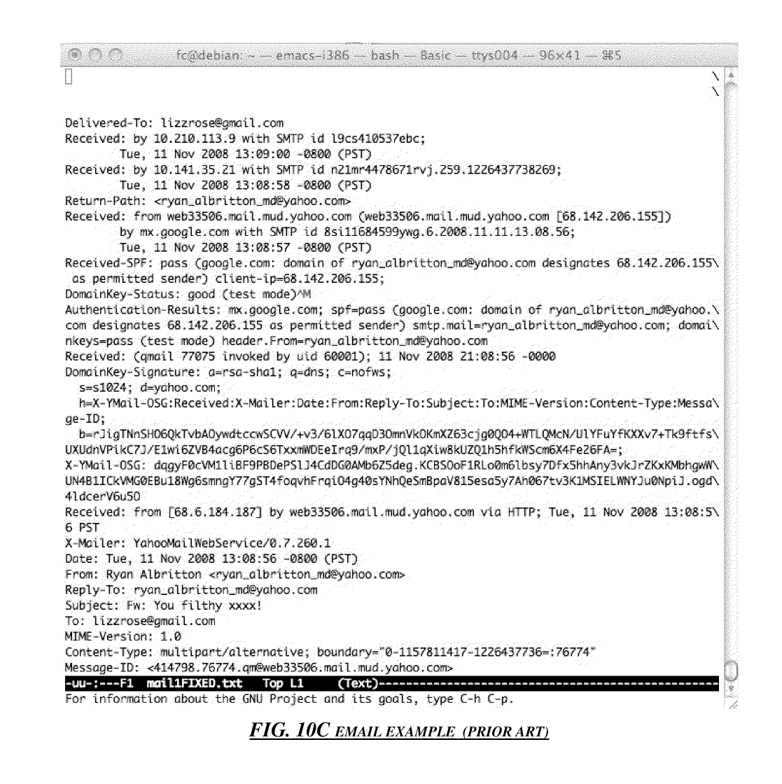

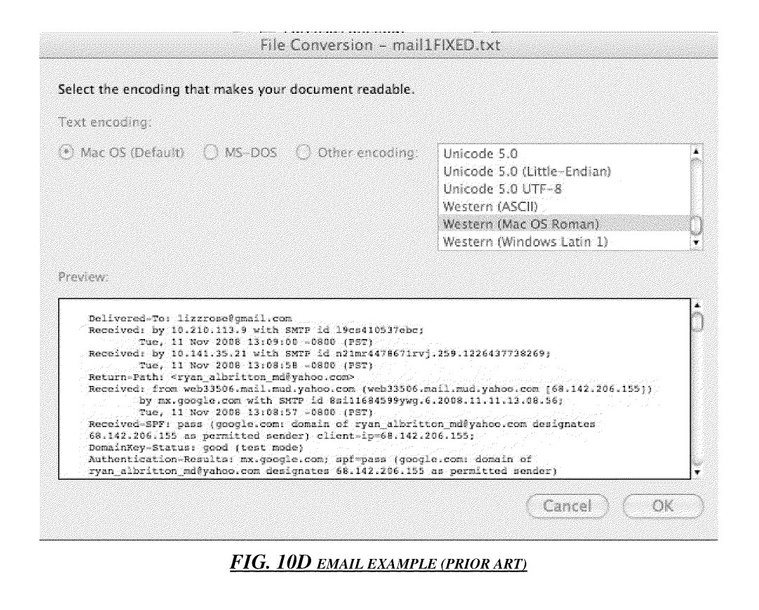

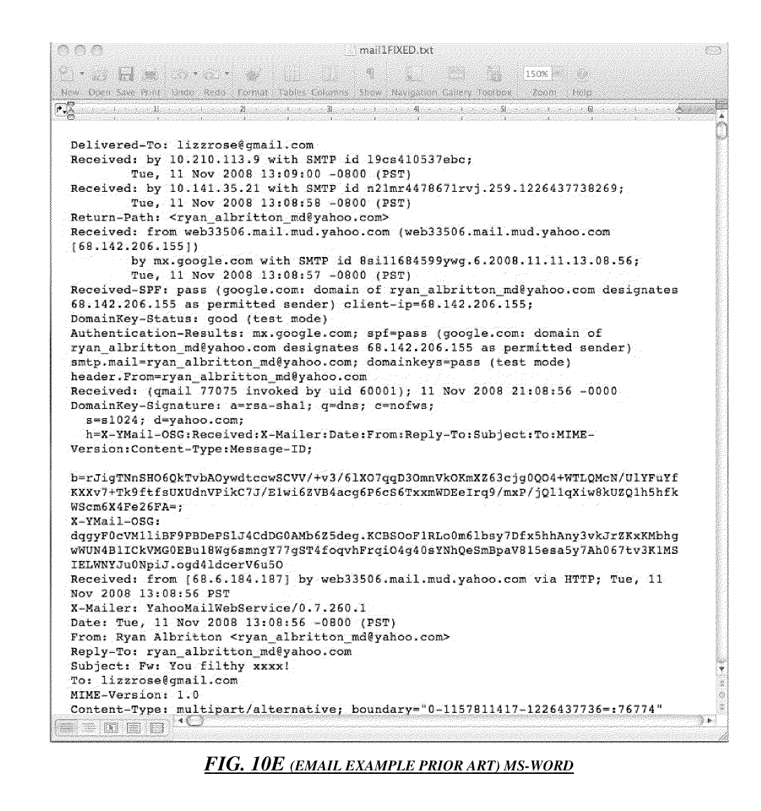

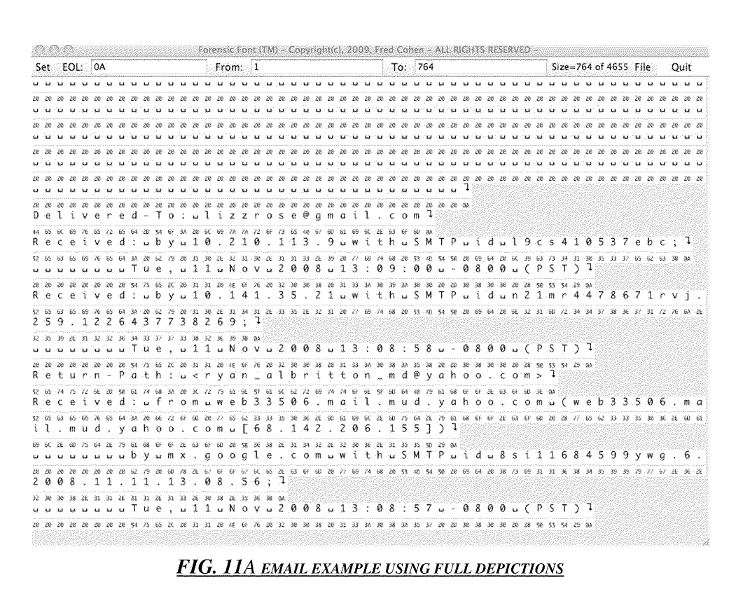

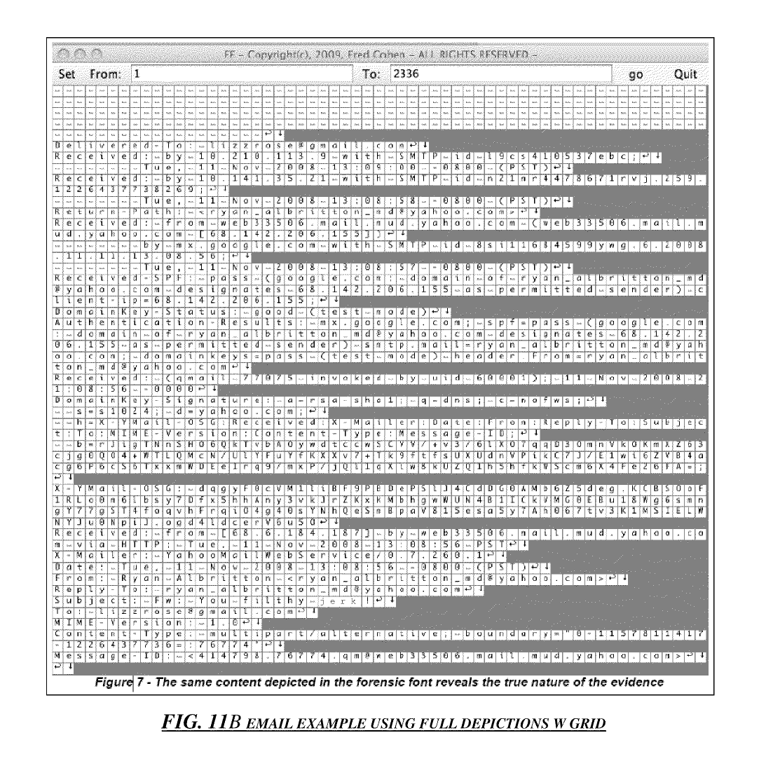

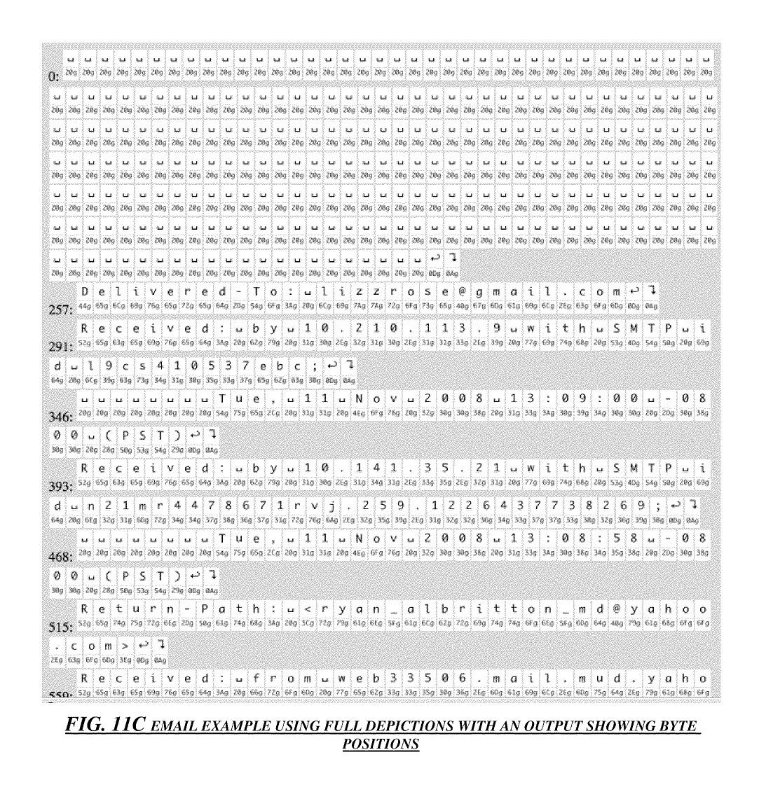

FIG. 10A-E and FIG. 11A-C illustrate aspects of the invention using examples from on a legal matter. Outputs as shown in FIG. 10 are problematic in terms of identifying precisely what byte sequences were present within the original content. FIG. 10A-E illustrates the file output using several different editing or email reading programs, each of which is problematic when attempting to document the underlying bit sequence of the file.

FIG. 11A, by contrast and according to specific embodiments of the invention, presents the header portion of the actual file using the forensic font (short form). In this case, it is immediately clear that there are a series of leading space characters followed by the content of the header, that <CR><LF> ends the lines, and that the apparent end of the header area in many of the previous depictions do not accurately reflect the lack of a second carriage return and linefeed at that point in the original content. In testifying with regard to the output partially depicted in FIG. 10, the expert had to indicate that the depiction was unclear and that recollection alone would have to be used to identify what was present in the header portion of this message.

The output from FIG. 11 is definitive. In FIG. 11, spacing is also used between symbols to provide clarity around the alignment across the page. Again, the fixed width font combined with the details of character codes used provides the capacity to gain clarity around what is actually present, even when the output results and wraparound.

FIG. 11B is a further example forensic output according to specific embodiments of the invention. In this example, a grid is provided for the output, with lines broken at places to better show the underlying bit sequences. In this example, the positions in the grid that do not indicate any underlying bit sequence are shaded gray to visually remind the viewer that every bit sequence is shown and that the spacing is added in the forensic output for clarity in viewing.

FIG. 11C is a further example forensic output as in FIG. 11B, but further providing bit sequence position indications.

### An Example HTML Implementation

In one implementation of a conversion program according to specific embodiments of the invention, the table shown in FIG. 1 is converted into a JPEG output file, and using the widely disseminated “convert” program, JPEG files corresponding to each ASCII code were extracted, with each being placed into a file named with either an F “full” or an S “small” followed by the two character HEX value followed by the extension “.jpg”.

Conversion for display is done by a simple program that extracts the hex value for each byte in the input file, and produces an HTML output file consisting of a sequence of image tags, with each image tag corresponding to the JPEG file associated with the ASCII code of the byte value. The conversion program also provides for specifying a width and height of the displayed output by using the HTML tags there with associated, and provides for the addition of new lines after user-defined end of line characters (e.g., 0A).

While this simple HTML implementation might be less desirable in some situations than a more traditionally implemented character or font set, with the power of the present invention, even this simple implementation is superior for displaying many types of digital data for forensic purposes than previously available methods.

In a production Forensic Font system, it is generally desirable to implement the symbols using a standard font encoding e.g., TrueType, Postscript, etc. except for portions of the code space that cannot be readily represented in this way.

### A Tool to Apply Forensic Fonts

An example tool for using Forensic Fonts™ according to specific embodiments of the invention is provided in the submitted source code appendix. The this tool is designated at times herein as “ff”. This particular example implementation was written in java and is provided as a “jar” file with executable and the files associated with the defined fonts identified herein. It provides a graphical interface to allow the user to display a file in the forensic font, and to manipulate the depictions for the sorts of examples described herein. This includes, without limit:

The presentation of a unique depiction for each of the eight-bit ASCII character codes.

The ability to resize and reshape the output window for ease of alignment.

The ability to display bites starting at any location within the input.

The ability to define characters for the depiction.

The ability to select between the “full font”, including numerical digits indicating byte values, identified herein, and a smaller version of that font that does not include numerical digits.

The ability to resize the font over a variety of different sizes.

While the invention may be embodied in various software systems and tools, a number of properties will generally be desired in any tool or method practiced according to the invention. The properties include, without limit: 1. No alteration or modification of the underlying digital data file; 2. Display or print presentation of all bit sequence information in the underlying data file (e.g., the display must be complete); 3. Display or print presentation that accurately and uniquely represents each bit sequence in the underlying data file. Further properties are desirable from a user standpoint, including the ability to indicate various encoding schemes, the ability to easily change the alignment of the display of the entire underlying data or of a portion, the ability to add some breaks or formatting to the display of the data file, while not altering the underlying data file and while still providing an output that unambiguously represents every bit sequence in the underlying data.

### Example Outputs

Example forensic outputs according to specific embodiments of the invention may be, without limit, in the form of pieces of paper, presentations using a computer display screen, or in files provided in digital form. A major goal of the invention is that the output be equally informative in all such forms. The production of digital forensic evidence, which includes elements that are hidden by nature, requires that the tools used to produce it are reliable and suited for the purpose, that the methodology meets the requirements of scientific rigor, and that it is properly applied. If the production is done with inadequate resolution to make the fonts readable or if the presentation method fails to properly display all of the symbols in proper sequence and placement, the use of forensic fonts will not alter those conditions. However, because the forensic font is self-indicating as to the underlying bit sequence present in the trace, the content should be clear to the properly skilled observer.

One software approach for presenting and printing larger volumes of material in the forensic font uses a Web browser and the hypertext markup language (HTML). One example uses the “hexdump” program and text replacement to create an HTML file that is about 20-30 times as large as the original content and that causes the Web browser to display the result by rendering a series of graphical files aligned so as to depict the desired results.

Web browsers typically have print functions, and on some platforms, these functions allow the output to be printed or saved as portable document format (pdf) files or postsript (ps) files. In these systems, this process may be used to produce a printable version that is relatively portable and can be sent electronically from place to place. PDF files are commonly used in legal productions within the United States today, and, as a result, producing PDF files that very accurately depict the underlying data is one very useful application of the invention. The present embodiment produces output in PDF format and includes, without limit, additional information on the date and time of the creation of the depiction, page numbering, the name of the file depicted, and the user identity used to produce the PDF file

### Logic Code Examples: Html Version Adding the Byte Location to the Front

For the purposes of example only, this application provides a number of examples of logic code that illustrates various aspects according to specific embodiments of the invention. This code is fully incorporated herein by reference, but is provided as an example and should not be construed to limit the invention except as provided in the attached claims.

The first example uses HTML in part to add byte location to the front of every region (regions defined by the newline character in this case, but different definitions can be used, including different characters acting as “line-breaks” or a set number of characters.). This example can be easily implemented done through a shell script feeding a Web browser.

### 1^{st} Example Shell Script Source Code

Run as “F ASCII F zz zz 0A 16 42 T purple” with the shell script named
“F”:
echo “F [ASCII/SIXBIT/EBCDEC] [FS] S0A.jpg test 0A 12 32 [T]”
echo “ Full or Small - input file - output file (.html) break

[width[height]] [Table BGcolor]”

FontFam=“/u/fc/.FF/$1”;shift
Font=$1;shift
InFile=$1;shift
OutFile=$1;shift
Break=$1;shift
if test “X$1” == “X”; then WL=“”;

else WL=“ width=\“$1\””;shift
if test “X$1” == “X”; then WL=“$WL”;

else WL=“$WL height=\“$1\””; shift; fi

fi

if test “X$1” == “X”; then

for i in \grave{ }hexdump -v $InFile | toupper |

while read a b; do echo $b;done\grave{ }; do

echo -n “<img src=$FontFam/$Font$i.jpg hspace=\“0\” vspace=

\“0\”$WL>”;

if test “$i” == “$Break”; then echo “<br>”; fi; done > $OutFile.html

else

echo “<table border=0 bgcolor=$2 cellspacing=0 ><tr>” > $OutFile.html
for i in \grave{ }hexdump -v $InFile | toupper |

while read a b; do echo $b;done\grave{ }; do

echo -n “<td> <img src=$FontFam/$Font$i.jpg hspace=\“0\” vspace=

\“0\”$WL>”;

if test “$i” == “$Break”; then echo “</tr><tr>”; fi; done >>

$OutFile.html
echo “</table>” >> $OutFile.html

fi

### 2d Example Shell Script Source Code

echo “F [ASCII/SIXBIT/EBCDIC] [FS] S0A.jpg test 0A 27 56/30 BGcolor
Spaces Table]” >> /dev/stderr
echo “ Full or Small - input file - output file (.html) break width
(27) height (56/30) color Spaces (T/F/!) Table (T/F)” >> /dev/stderr
echo “ Example: F ASCII F zz zz 0A 15 28 purple F F - from zz to
zz.html Newline Wid/High BGcolor NoSpaces No-table” >> /dev/stderr
echo “ Example2: F - - - - - -/+ -/+ - - - - (default) ASCII F from
STDIN to STDOUT Newline=0A Wid=14/18 High=28/36 BGcolor=white NoSpaces
No-table ShowCount” >> /dev/stderr
FontFam=$1;shift; if test “Z$FontFam” == “Z”; then FontFam=“−”;fi
Font=$1;shift; if test “Z$Font” == “Z”; then Font=“−”;fi
InFile=$1;shift; if test “Z$InFile” == “Z”; then InFile=“−”;fi
OutFile=$1;shift; if test “Z$OutFile” == “Z”; then OutFile=“−”;fi
Break=$1;shift; if test “Z$Break” == “Z”; then Break=“−”;fi
Wid=$1;shift; if test “Z$Wid” == “Z”; then Wid=“−”;fi
Len=$1;shift; if test “Z$Len” == “Z”; then Len=“−”;fi
BGColor=$1;shift; if test “Z$BGColor” == “Z”; then BGColor=“−”;fi
Space=$1;shift; if test “Z$Space” == “Z”; then Space=“−”;fi
Table=$1;shift; if test “Z$Table” == “Z”; then Table=“−”;fi
ShowCount=$1;shift; if test “Z$ShowCount” == “Z”; then ShowCount=“−”;fi
echo “FF $FontFam $Font $InFile $OutFile $Break $Wid $Len $BGColor
$Space $Table” >> /dev/stderr

if test $FontFam == “−”; then FontFam=“/u/fc/.FF/ASCII”; else

FontFam=“/u/fc/.FF/$FontFam”;fi;shift

if test $Font == “−”; then Font=“F”;fi
if test $InFile == “−”; then InFile=“”;fi
if test $Break == “−”; then Break=“0A”;fi
if test $Wid == “−”; then WL=“ width=\“14\””; else

if test $Wid == “+”; then WL=“ width=\“18\””; else

WL=“ width=\“$Wid\””; fi; fi; shift

if test $Len == “−”; then WL=“$WL height=\“28\””; else

if test $Len == “+”; then WL=“$WL height=\“36\””

else WL=“$WL height=\“$Len\””

fi; fi; shift

if test $BGColor == “−”; then BGColor=“gray”;fi
if test $Space == “!”; then hspace=0; vspace=0;
border=0;Spacer=“|”;LineSpacer=“<hr>”; else

if test $Space == “T”; then hspace=1; vspace=1;

border=1;Spacer=“”;LineSpacer=“”;

else hspace=0; vspace=0; border=0;Spacer=“”; LineSpacer=“”; fi

fi
if test $ShowCount == “−”; then ShowCount=“T”;fi

let count=0
if test “$Table” == “T”; then

echo “<table width=100% border=$border bgcolor=$BGColor

cellspacing=0><tr>”

if test $ShowCount == “T”; then echo “<th>$count</th>”;fi
for i in \grave{ }hexdump -v $InFile | toupper |

while read a b; do echo $b;done\grave{ }; do

echo -n “<td> <img src=$FontFam/$Font$i.jpg hspace=\“0\” vspace=

\“0\”$WL>”;let count=$count+1;

if test “$i” == “$Break”; then echo “</tr><tr>”;

if test $ShowCount == “T”; then echo “<th>$count</th>”; fi; fi; done

echo “</td></table>”

else

echo “<body bgcolor=$BGColor>”
if test $ShowCount == “T”; then echo “$count:&#09 ”; fi
for i in \grave{ }hexdump -v $InFile | toupper |

while read a b; do echo $b;done\grave{ }; do

echo -n “<img src=$FontFam/$Font$i.jpg hspace=$hspace vspace=

$vspace $WL>$Spacer”;let count=$count+1;

if test “$i” == “$Break”; then

if test $ShowCount == “T”; then echo “<br> $count:&#09”; else echo

“<br>”;fi;fi; done
# if test $ShowCount == “T”; then echo “<br>$count:&#09”;fi
fi | if test $OutFile == “−”; then cat; echo “Done $OutFile” >> /dev/
stderr; else cat > $OutFile.html; echo “Done $OutFile.html” >> /dev/
stderr ; fi

### Software Tools and Additional Embodiments

The invention in different embodiments can involve only a Forensic Fonts™ depiction set as described herein or can further involve one or more software tools using such depiction sets. Software tools can provide static or interactive output and allow a user to select various options regarding the depiction output of the underlying data. Such tools can handle various alignment issues, such as tab stops, differences in appearance between the forensic font display in the normal display seen by user, the additional information present in the forensic font that makes cognition of content somewhat slower, and the fact that one format of depiction output may not be the best for all situations. Thus, the invention according to specific embodiments provides methods for more rapidly understanding the byte sequences present, for reducing content miss and make errors in the interpretation process, and for presenting forensic output to others when the underlying bit sequences are relevant to the issues in the case.

In some of the implementation examples described herein the mechanisms used to transform a display are rudimentary, and were designed simply to demonstrate the concept. While even these simple implementations are very useful in some situations, other embodiments of the invention include improvements in both the fonts and the tools. In some embodiments, the invention provides depiction sets that provide fonts that are directly usable within browsers, terminal windows, document editors, and throughout the forensic process and tools, allow for more widespread and easier use of the invention.

The creation of forensic fonts for other character sets will also be helpful. For example, the implementation of an EBCDIC and SIXBIT fonts, were a simple matter, and they are helpful in examining exchanges and stored information in those representations. Similarly, other common representations, such as Unicode, seven bit ASCII with parity, etc. would be useful, and more generally, the capacity to create fonts sets for a wide range of different situations with relatively little effort would be helpful so that examiners can create font sets on-the-fly for presentation of specific data for specific uses.

### Other Variations

The present invention can in specific embodiments also involve different display or printing output formats and other characteristics that are desirable in specific situations.

As a first example, in some situations, it may be helpful to use one depiction to depict longer or shorter bit sequences in order to provide clarity to issues regarding larger files or files that include regular delimited data, such as database or spread-sheet files. In such a case, one depiction in a system of the invention can be understood to represent longer or shorter bit sequences as required in a particular context.

An output according to specific embodiments of the invention can also include displaying select portions of content while identifying which portions are depicted. This is done by limiting the potion of the input depicted and using the location information described earlier and shown in the figures. In this case, the sequence displayed can start and end anywhere within any bit sequence regardless of format and be displayed as a unique depiction relative to that context.

Thus, the invention according to specific embodiments can include depictions for data values such as integers, stored timestamps, delimiters, and other similar representations of multibyte or sub-byte values, using depictions specific to the format type, including the location of the content, and providing for forensic examination. As another example, a compressed file has bit sequences of different lengths representing depictions and they may be displayed even if they are not each a byte long. Field separators can be identified and displayed as a field separator depiction followed by (or proceeded by) a formatting change, such as displaying the next column or row in a table.

In general terms, the invention in specific embodiments can be understood as a way to present or display digital data comprising: (1) determining a depiction set for sequences of one or more bits possible in a digital file is represented by a distinct depiction; (2) reading the contents of a digital file; (3) without modifying the contents of an original digital file, outputting depictions for bit sequences, such that every bit sequence is represented by a distinct depiction.

Note that all the following are possible while meeting the above description, and may be implemented according to specific embodiments.
1. It is possible that a single depiction character can represent a very long bit sequence. For example, in a case where a data file contains an often repeated bit sequence of 1028 (or any number) of bytes, the invention can assign one depiction to that bit sequence and use that in the output. This allows a user to review the output more easily while still knowing exactly what the underlying bit sequences are. There are no hidden bit sequences, and in particular embodiments, every one-bit change in a data file will be guaranteed to produce a visible change in the forensic output.
2. As a slight relaxation to the above, it is possible for a forensic output to use one or more well-defined rules so that some bit-sequences are not uniquely mapped. For example, if a particular forensic analysis determines that certain byte values (e.g., a ‘null’ value) are irrelevant to the analysis for some reason, the forensic output can include a depiction that can represent any number of sequential null values. By way of example, it could indicate a numeric value (e.g., 29890) followed by a depiction to indicate that there are that many of the depicted bit sequence in a row at that location Alternatively, the forensic output can include a depiction (or multiple depictions) that indicate the number of a sequential values, such as two sequential depictions, with the first indicating the beginning of a sequence of null values and the second indicating the number of values in the sequence. While it is also possible for specific embodiments to provide that a particular bit sequence (such as a “null”) does not result in a depiction, this is not a presently preferred embodiment.
3. It is possible that a single depiction character can represent a short or variable bit sequence. For example, in some types of compressed encodings, different characters are encoded according to their frequency in the language or in the text in a particular file. In such a case, output according to specific embodiments of the invention can read the compressed code and still output one depiction for every encoded character.
4. In a further embodiment, the invention may output different depictions for the same bit sequence value depending on the context. For example, the invention may output a “tab” bit sequence as different width depictions in different contexts in order to preserve some aspects of formatting. For another example, if a particular digital file contains a text portion (e.g., a header or label) and a delimited data portion (e.g., a database, spreadsheet or table), the invention may output a depiction indicating a letter or digit in the text portion of the file for a bit sequence there, and a different symbol indicating a field delimited in a different portion of the output that falls within the delimited data portion. This type of output may be directed by a user indicating which portions of a file are text and which are structured data.

### Embodiment in a Programmed Digital Apparatus

The invention may be embodied in a fixed media or transmissible program component containing logic instructions and/or data that when loaded into an appropriately configured computing device cause that device to perform in accordance with the invention.

As will be understood to practitioners in the art from the teachings provided herein, the invention can be implemented in hardware and/or software. In some embodiments of the invention, different aspects of the invention can be implemented in either client-side logic or server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media containing logic instructions may be delivered to a user on a fixed media for physically loading into a user's computer or a fixed media containing logic instructions may reside on a remote server that a viewer accesses through a communication medium in order to download a program component.

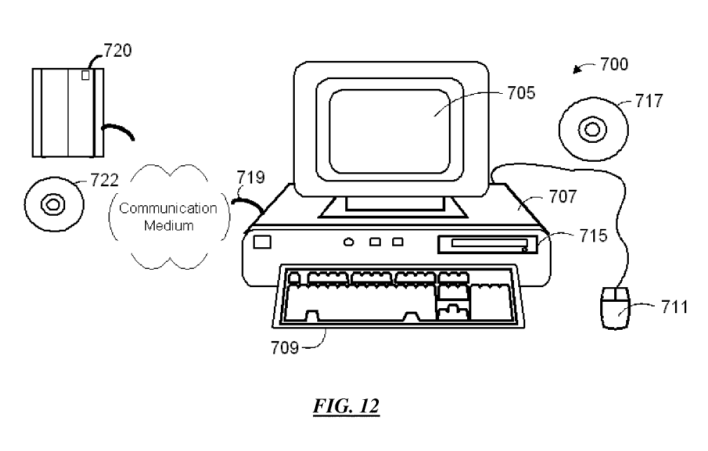

FIG. 12 shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of the invention. One type of logical apparatus that may embody the invention is a computer system as illustrated in 700, containing CPU 707, optional input devices 709 and 711, disk drives 715 and optional monitor 705. Fixed media 717, or fixed media 722 over port 719, may be used to program such a system and may represent a disk-type optical or magnetic media, magnetic tape, solid state dynamic or static memory, etc. In specific embodiments, the invention may be embodied in whole or in part as software recorded on this fixed media. Communication port 719 may also be used to initially receive instructions that are used to program such a system and may represent any type of communication connection.

The invention also may be embodied in whole or in part within the circuitry of an application specific integrated circuit (ASIC) or a programmable logic device (PLD). In such a case, the invention may be embodied in a computer understandable descriptor language that may be used to create an ASIC or PLD that operates as herein described.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

What is claimed:

1. A method for presenting digital data from a digital data system, the system of a type that assigns visual symbols to bit sequences where some bit sequences of the system are not assigned to visual symbols, the method comprising:
assigning to every bit sequence not assigned to a visual symbol, a forensic depiction, where each forensic depiction is visually distinct from every other forensic depiction and visually distinct from every visual symbol;
so that every bit sequence is associated with a depiction: and
outputting to a visual media digital data, where every bit sequence is output as a visual depiction.

2. The method of claim 1 further wherein the digital data system is of a type wherein some visual symbols assigned to bit sequences are not readily visually distinct from other normally printable symbols, the method further comprising:
assigning a modified distinct normally printable symbol to at least one of any set of two or more bit sequences that are assigned to normally pintable symbols that are not visually distinct.

3. The method of claims 1 to 3 further comprising:
assigning a forensic printable symbol for every normally printable symbol, said forensic normally printable symbol having attributes desirable for forensic analysis but being visually recognizable as the normally printable symbol.

4. The method of claims 1 to 3 further comprising providing at least two types of forensic depictions: (A) forensic depictions for normally printable bit sequence; and (B) forensic depictions for normally non-printing bit sequence.

5. The method of claims 1 to 4 further wherein:
each assigned forensic depiction includes a symbol portion and a value portion, the value portion visually indicating a value for the bit sequence.

6. The method of claims 3 to 5 further wherein:
each forensic normally printable symbol includes a forensic normally printable symbol portion and a value portion, the value portion indicating a numerical value of the bit sequence.

7. The method of claims 1 to 6 further wherein:
more than one distinct forensic symbol may be assigned to a bit sequence, with different distinct forensic symbols output for a same bit sequence depending upon the context of the bit sequence.

8. The method of claim 7 further comprising:
including with more than one distinct forensic symbol assigned to a bit sequence numerical digits indicating a bit sequence, where the numerical digits remain the same in different contexts of the bit sequence.

9. The method of claims 1 to 8 further comprising:
outputting exactly one distinct forensic symbol for each bit sequence.

10. The method of claims 1 to 9 further comprising:
including spacing and or formatting in the outputting to a visual media, where the spacing may be indicated by bit sequences, but where every bit sequence is also output as a visible symbol.

11. The method of claims 1 to 10 further wherein:
substantially every bit sequence comprises the same number of bits, e.g., 4, 7, 8, 9, 16, 32.

12. The method of claims 1 to 11 further wherein:
any change to any bit in the input file is guaranteed to change at least one output depiction.

13. The method of claims 1 to 12 further wherein:
bit sequence can have variable width.

14. The method of claims 1 to 13 further wherein:
a forensic depiction may depict longer or shorter bit sequences in order to provide clarity to issues regarding larger files or files that include regular delimited data, such as database or spread-sheet files.

15. The method of claim claims 1 to 14 further comprising:
providing additional forensic depictions for data values such as integers, stored timestamps, delimiters, and other similar representations of multibyte or sub-byte values.

16. The method of claims 1 to 15 further comprising:
providing additional forensic depictions specific to the format type, including the location of underlying digital data.

17. The method of claims 1 to 16 further comprising:
displaying field separators and/or linebreaks or other delimiting characters as a forensic depiction followed or proceeded by a formatting change, such as displaying the next column or row in a table, the next line, or spacing for tabs.

18. The method of claims 1 to 17 further comprising:
providing a user interface allowing a user to dynamically and interactively make presentation adjustments to the visualization output where the presentation adjustments do not modify any of the original bit sequences.

19. The method of claim 18 further wherein the presentation adjustments comprise one or more of:
setting overall margins of the output or portions or the output;
placing spacing indications between any two original bit segments;
associating spacing indications with all or a subset of particular bit sequences; and
changing a forensic font symbol for all or a subset of particular bit sequences;
further wherein any such presentation adjustments makes no modification to the underlying original bit sequence and further wherein each bit sequence remains output as a visual symbol.

20. The method of claim 18 further wherein the presentation adjustments comprise one or more of:
outputting select portions of content while identifying which portions are depicted by limiting the potion of the input depicted and using location information inputs to indicate a range of data to output.

21. A device for visually presenting characters representing digital data comprising:
electronically accessible digital memory for storing data representing a plurality of visible symbols;
the memory storing data indicating a correspondence between allowed values in bit-segment encoded digital data and the plurality of visible symbols;
a logic controller able to read an input digital data stream, able to look-up visible symbols from the memory, and able to output to an output device a sequence of visible symbols where there is a unique and specific correspondence between a distinct visible symbol and a value in the input digital data stream;
an electronic output module able to render a sequence of visible symbols in an output visible to a human viewer.

22. The system of claim 21 further wherein:
said electronic output module is a printer.

23. The system of claim 21 further wherein:
said electronic output module is an electronic display device.

24. A method for presenting digital data comprising:
assigning a forensic depiction to every bit sequence, each forensic depiction visually distinct from every other forensic depiction;
so that every bit sequence is associated with a forensic depiction: and
outputting to a visual media digital data, where every bit sequence is output as a forensic depiction.

25. The method of claim 24 further comprising providing at least two types of forensic depictions:
(A) forensic depictions for normally printable bit sequence; and (B) forensic depictions for normally non-printing bit sequence.

26. The method of claims 24 to 25 further wherein:
each forensic depiction includes a symbol portion and a value portion, the value portion visually indicating a value for the bit sequence.

27. The method of claims 24 to 25 further wherein:
each forensic depiction includes a symbol portion that, for normally printing symbols, is recognizable as the normally printable symbol and is distinct from any other normally printing symbol.

28. The method of claims 24 to 27 further wherein:
more than one distinct forensic symbol may be assigned to a bit sequence, with different distinct forensic symbols output for a same bit sequence depending upon the context of the bit sequence.

29. The method of claims 24 to 28 further comprising:
including with more than one distinct forensic symbol assigned to a bit sequence numerical digits indicating a bit sequence, where the numerical digits remain the same in different contexts of the bit sequence.

30. The method of claims 24 to 29 further comprising:
outputting exactly one distinct forensic symbol for each bit sequence.

31. The method of claims 24 to 30 further comprising:
including spacing and or formatting in the outputting to a visual media, where the spacing may be indicated by bit sequences, but where every bit sequence is also output as a visible symbol.

32. The method of claims 24 to 31 further wherein:
substantially every bit sequence comprises the same number of bits, e.g., 4, 7, 8, 9, 16, 32.

33. The method of claims 24 to 32 further wherein:
any change to any bit in the input file is guaranteed to change at least one output depiction.

34. The method of claims 24 to 33 further wherein:
bit sequence can have variable width.

35. The method of claim 24 to 34 further comprising:
providing a user interface allowing a user to dynamically and interactively make presentation adjustments to the visualization output where the presentation adjustments do not modify any of the original bit sequences.

36. The method of claim 35 further wherein the presentation adjustments comprise one or more of:
setting overall margins of the output or portions or the output;
placing spacing indications between any two original bit segments;
associating spacing indications with all or a subset of particular bit sequences; and
changing a forensic font symbol for all or a subset of particular bit sequences;
further wherein any such presentation adjustments makes no modification to the underlying original bit sequence and further wherein each bit sequence remains output as a visual symbol.

37. A method for presenting digital data comprising:
determining a set of depictions for sequences of one or more bit sequences in a digital file so the each possible bit sequence is represented by a distinct depiction;
reading the contents of a digital file;
without modifying the contents of an original digital file, outputting depictions for bit sequences, such that every bit sequence is represented by a distinct depiction.
